(19) United States
(12) Patent Application Publication
(10) Pub. No.: US 2009/0246039 A1
(43) Pub. Date: Oct. 1, 2009

(54) CARRIER ASSEMBLY FOR A PUMP

(75) Inventors: RYAN HAACK, LAWRENCE, KS (US); STEVEN P. HOFFMANN, OVERLAND PARK, KS (US)

Correspondence Address: THE SMALL PATENT LAW GROUP LLP, 225 S. MERAMEC, STE. 725T, ST. LOUIS, MO, 63105, US

(73) Assignee: GRUNDFOS PUMPS CORPORATION, OLATHE, KS (US)

(21) Appl. No.: 12/466,546

(22) Filed: May 15, 2009

Related U.S. Application Data
(63) Continuation-in-part of application No. 11/328,320, filed on Jan. 9, 2006, now abandoned.

(51) Int. Cl. F04D 29/60; B23P 6/00

(52) U.S. Cl. 417/244; 29/888.021

(57) ABSTRACT

A pump assembly includes a manifold having an inlet port configured to be coupled to a supply pipe and an outlet port configured to be coupled to a discharge pipe. The pump assembly also includes a cartridge having a pump stack including a plurality of pumping stages. Each pumping stage includes an impeller. The cartridge extends between a first end and a second end. The first end is removably coupled to the manifold. A carrier assembly supports the cartridge. The carrier assembly moves the cartridge between an advanced position and a retracted position. The cartridge engages the manifold in the advanced position and the cartridge is disengaged from the manifold in the retracted position. Optionally, the carrier assembly may include a support frame and at least one rail. The support frame is slidable along the rail and the cartridge is supported by the support frame.

### CROSS-REFERENCE RO RELATED APPLICATIONS

This application is a continuation-in-part of U.S. application Ser. No. 11/328,320, filed Oct. 8, 2007, which claims the benefit of U.S. Provisional Application No. 60/850,861 filed Oct. 10, 2006, the complete subject matter of both of which are expressly incorporated herein by reference in their entirety.

### BACKGROUND OF THE INVENTION

The subject matter herein relates generally to pump assemblies, and more particularly, to multistage pump assemblies having removable cartridges.

Pump assemblies are provided within pipe systems of residential, commercial or industrial facilities for increasing the pressure and flow of the fluid within the pipe system. The pump assembly is usually fitted to the pipe system to circulate the fluid under pressure. The typical pump assembly has an inlet that supplies fluid to the pump through a manifold having an impeller chamber, an impeller located in the chamber, a power head (e.g. motor and shaft) to drive the impeller, and an outlet that returns the fluid to the pipe system. The inlet is fitted to a supply pipe and the outlet is fitted to a discharge pipe. The size of the pump assembly is selected based on the particular pipe system and the desired pressure and flow of the fluid within the pipe system. For example, various pump assembly components may be provided to accommodate various sized supply pipes and discharge pipes, which are typically different than one another. The particular pump assembly components chosen depend on the particular application. In another example, in applications where a high pressure is desired, a pump assembly having a relatively larger motor or a relatively larger impeller may be used. In some known pump assemblies, multiple impellers are used, such as in a multistage pump assembly.

The multistage pump assemblies typically have one of two configurations, namely a horizontal configuration and a vertical configuration. In both configurations, the pump assemblies typically stack the multiple impellers in stages in series. In the horizontal configuration, the stack is oriented generally horizontally when installed; and in the vertical configuration, the stack is oriented generally vertically when installed.

In a typical horizontal configuration, the manifold having the inlet is positioned at one end of the stack and the outlet is positioned within a pump head at the opposite end of the stack. These types of pump assemblies include a motor shaft being supported by a shaft bearing within the motor. The impellers are directly coupled to the motor shaft. A drawback with this type of configuration is the number of stages that may be used is limited, due to the drive capacity of motor and the weight of the shaft and the impellers on the shaft bearing. Additionally, this design is complicated to manufacture and assemble. Additionally, repair and/or replacement of the pump stack and/or pump head is difficult and requires that the majority of the pump assembly (e.g. the manifold, each stage, and the pump head) be completely disassembled for servicing.

A need remains for a pump assembly, operable in a horizontal configuration, that can be assembled in a cost effective and reliable manner. A need remains for a pump assembly that may be serviced or replaced in an efficient manner.

### BRIEF DESCRIPTION OF THE INVENTION

In one embodiment, a pump assembly is provided that includes a manifold having an inlet port configured to be coupled to a supply pipe and an outlet port configured to be coupled to a discharge pipe. The pump assembly also includes a cartridge having a pump stack including a plurality of pumping stages. Each pumping stage includes an impeller. The cartridge extends between a first end and a second end. The first end is removably coupled to the manifold. A carrier assembly supports the cartridge. The carrier assembly moves the cartridge between an advanced position and a retracted position. The cartridge engages the manifold in the advanced position and the cartridge is disengaged from the manifold in the retracted position. Optionally, the carrier assembly may include a support frame and at least one rail. The support frame is slidable along the rail and the cartridge is supported by the support frame.

In another embodiment, a method is provided of servicing a pump assembly that includes a manifold and a cartridge removably coupled to the manifold, where the manifold is coupled to a supply pipe and a discharge pipe. The method includes providing a carrier assembly including a support frame and a rail, where the support frame is movable along the rail and the cartridge is supported by the support frame and coupled to the manifold. The method also includes uncoupling the cartridge from the manifold, and guiding the support frame and the cartridge along the rail away from the manifold to a retracted position. Optionally, the method may also include the steps of guiding the support frame and the cartridge along the rail toward the manifold to an advanced position where the cartridge engages the manifold, and coupling the cartridge to the manifold. The method may include the steps of removing the cartridge from the support frame and replacing the cartridge with a new cartridge.

In a further embodiment a pump family of multistage pump assemblies is provided including a manifold having an inlet port configured to be coupled to a supply pipe and an outlet port configured to be coupled to a discharge pipe, where the manifold having a mating interface. The pump family also includes a pump motor and a carrier assembly supporting the pump motor. The carrier assembly moves the pump motor relative to the manifold. A first pump unit is provided that includes a cartridge having an end plate, a pump head opposite the end plate and a pump stack extending between the end plate and the pump head. The pump stack of the first pump unit has M number of pumping stages. A second pump unit is provided that includes a cartridge having an end plate, a pump head opposite the end plate and a pump stack extending between the end plate and the pump head. The pump stack of the second pump unit has N number of pumping stages different than the M number of pumping stages of the first pump unit. The first and second pump units are configured to be separately coupled to the manifold and the pump motor. The end plates are configured to be coupled to the manifold at a separable manifold interface./ The pump heads are configured to be coupled to the pump motor at a separable motor interface.

### BRIEF DESCRIPTION OF THE DRAWINGS

FIG. 1 is a side perspective view of a pump assembly formed in accordance with an exemplary embodiment.

FIG. 2 is an exploded, partial cutaway view of a cartridge and manifold of the pump assembly shown in FIG. 1.

FIG. 3 illustrates the pump assembly shown in FIG. 1 in a retracted state with the cartridge retracted from the manifold.

FIG. 4 illustrates the pump assembly with an alternative cartridge being coupled to the manifold.

FIG. 5 illustrates an alternative carrier assembly for the pump assembly shown in FIG. 1.

### DETAILED DESCRIPTION OF THE INVENTION

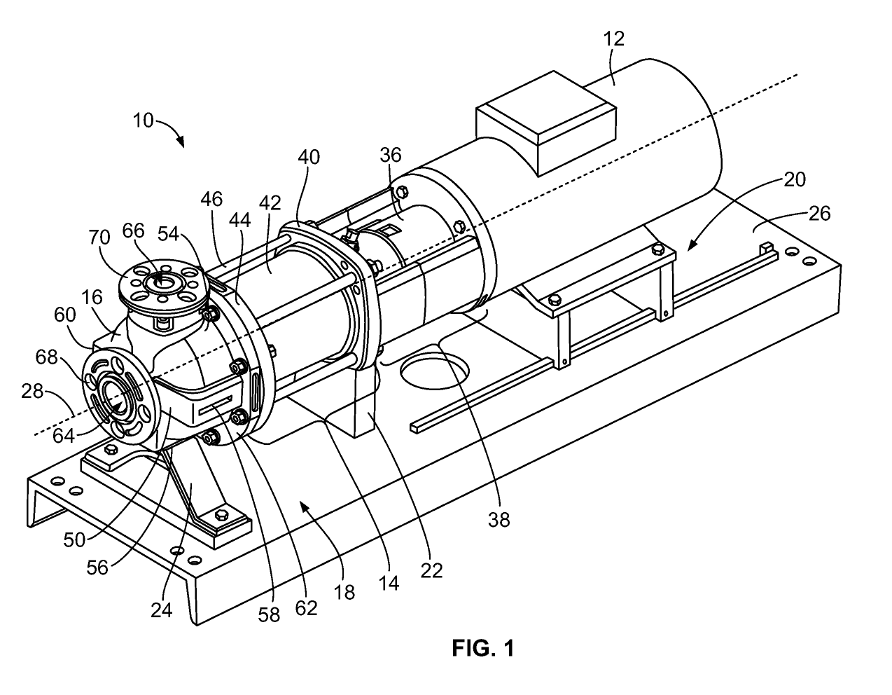

FIG. 1 is a side perspective view of a pump assembly 10 formed in accordance with an exemplary embodiment. The pump assembly 10 includes a pump motor 12, a cartridge 14 coupled to the pump motor 12 and a manifold 16 coupled to the cartridge 14. The pump assembly 10 may be installed in an existing or new pipe system to a supply pipe and a discharge pipe (not shown) for increasing the pressure and/or flow of water or another fluid within the pipe system. In the illustrated embodiment, the pump assembly 10 represents a horizontal pump assembly that may be mounted to a base 18 via a plurality of supports or braces, such as carrier assembly 20, a pump stack support 22, and volute supports 24. The base 18 also includes a baseplate 26, to which the carrier assembly 20, pump stack support 22, and volute supports 24 are mounted. The baseplate 26 is generally planar and is oriented horizontally, and may be mounted, directly or indirectly to a ground or building surface (not shown). In alternative embodiments, the pump assembly 10 may be provided without the baseplate 26, with the carrier assembly 20, pump stack support 22, and volute supports 24 mounted directly to the ground or building surface. While various embodiments of horizontal pump assemblies are described below, it is understood that the pump assembly 10 may be beneficial in other, non-horizontal applications as well. The following embodiments are therefore provided for illustrative purposes only.

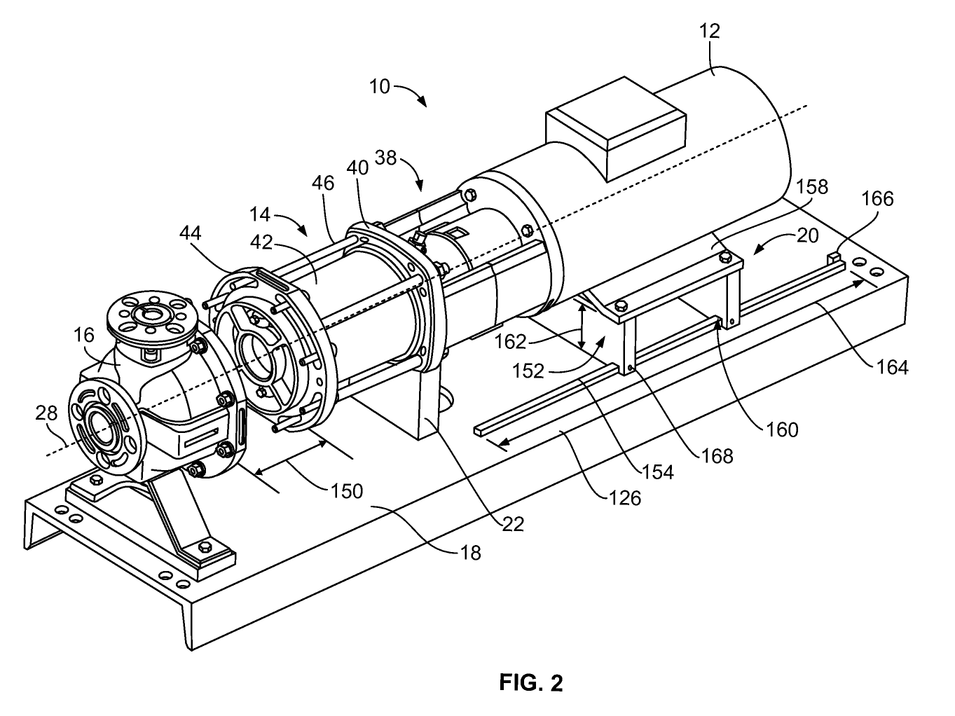

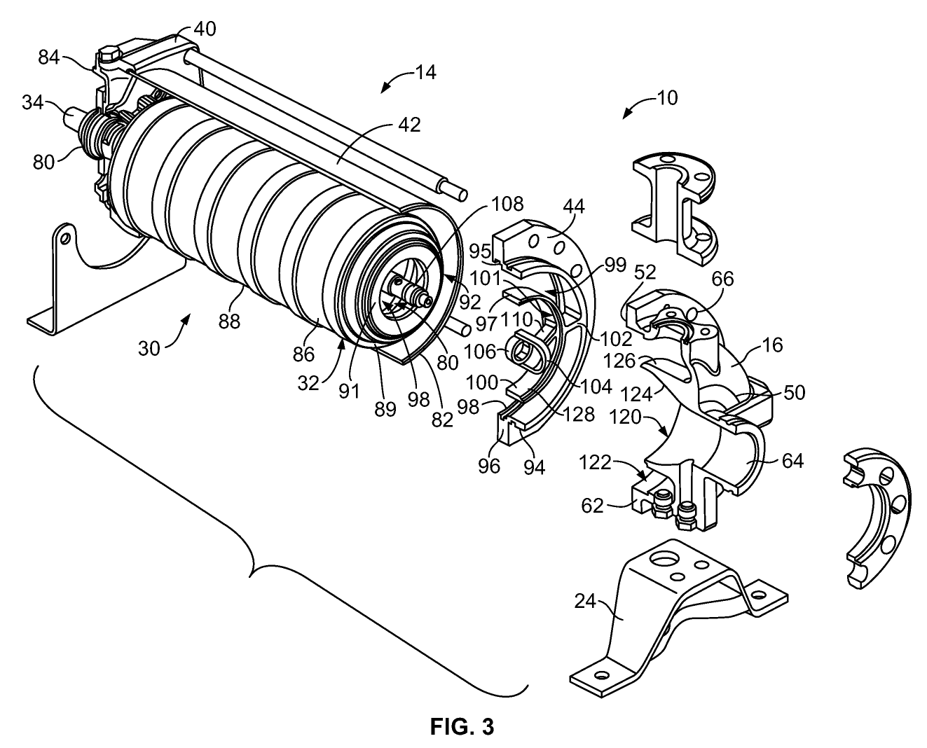

The pump motor 12, the cartridge 14 and the manifold 16 are axially aligned with one another along a longitudinal or rotation axis 28. The cartridge 14 includes a multistage pump stack 30 (shown in FIG. 2) having a plurality of pumping stages 32 (shown in FIG. 3) of impeller assemblies and diffusers.

The motor 12 includes a motor shaft (not shown) aligned with the rotation axis 28, and the pump stack 30 includes a pump shaft 34 (shown in FIG. 2) aligned with the rotation axis 28. The motor shaft may be coupled to the pump shalt 34, such as by a shaft coupling (not shown) for transmitting torque from the motor shaft to the pump shaft 34. The shaft coupling may be housed within an enclosure 36 extending at least partially between the motor 12 and the cartridge 14. The enclosure 36 may form part of a motor coupler 38, which couples the cartridge 14 to the pump motor 12.

The cartridge 14 defines a pump unit that includes the pump stack 30, a pump head 40, a sleeve 42 and an end plate 44. The sleeve 42 surrounds the pump stack 30. The pump stack 30 and the sleeve 4 generally extend between the pump head 40 and the end plate 44. In the illustrated embodiment, the end plate 44 is represented by a sleeve flange and may be referred to hereinafter as sleeve flange 44, however the end plate 44 may have different shapes, components and configurations in alternative embodiments. The end plate 44 is arranged at a first end of the cartridge 14 and the pump head 40 is arranged at a second end of the cartridge 14. The pump stack 30, sleeve 42, end plate 44 and pump head 40 are secured together to define a pump unit that may be physically handled and transferred as a single unit. As such, the cartridge 14 is self-contained or otherwise assembled together and may be uncoupled from the manifold 16 and/or the motor 12 or motor coupler 38 as a single unit for servicing or repair. For example, the end plate 44 may be decoupled from the manifold 16 and the cartridge 14 moved away from the manifold 16. The end plate 44 operates to hold the sleeve 42 and the pumping stages 32 of the pump stack 30 together relative to one another for removal. The cartridge 14 may be held together sufficient enough to allow the components of the cartridge 14 to be transported together, where the relative positions of the components of the cartridge 14 are substantially maintained.

The sleeve 42 has a generally circular cross section and defines a chamber through which the fluid flows. In the illustrated embodiment, and as will be explained in greater detail below, the cartridge 14 includes an inner chamber and an outer chamber through which the fluid is channeled. The sleeve 42 defines a radially outer surface of the outer chamber. The sleeve flange 44 is separately provided from, and coupled to the sleeve 42. The sleeve flange 44 is retained in place with respect to the sleeve 42 and the pump head 40 by multiple staybolts 46 extending between the pump head 40 and the sleeve flange 44.

In the illustrated embodiment, the manifold 16 constitutes a volute that may be coupled to a supply pipe and a discharge pipe of a pipe system, and may be referred to hereinafter as a volute 16. The manifold 16 directs fluid now from the supply pipe to the cartridge 14 and from the cartridge 14 to the discharge pipe. The manifold 16 includes a front end 50, a rear end 52, a top 54, a bottom 56, and sides 58 and 60. The volute support 24 may be coupled to the bottom 56 using known fasteners or known fastening methods. Alternatively, a pair of volute supports 24 may be coupled to the sides 58, 60. Other configurations of supports for the manifold 16 are possible. In one embodiment the manifold 16 is supported by the attachment to the supply and discharge pipes and an additional support is not provided.

The manifold 16 is coupled to the sleeve flange 44 via a volute flange 62 extending radially outward at the rear end 52 of the manifold 16, such as using known fasteners and known fastening methods. The manifold 16 is coupled to the sleeve flange 44 such that the manifold 16 is in fluid communication with the cartridge 14. The sleeve flange 44 represents an interposer that is positioned between the manifold 16 and the pump stack 30 and between the manifold 16 and the sleeve 42. Optionally, the cartridge 14 may be sealed against one side of the sleeve flange 44 and the manifold 16 may be sealed against the other side of the sleeve flange 44, such as by using gaskets.

In the illustrated embodiment, the manifold 16 represents an end-suction volute having an inlet 64 at the front end 50 and an outlet 66 at the top 54. The inlet and outlet 64, 66 may define ports through which fluid flows from respective supply and discharge pipes. The inlet 64 and the outlet 66 are non-parallel with respect to one another, such that the manifold 16 has a non-in-line configuration (e.g. an orientation in which the inlet and the outlet are not aligned with one another along an axis). Optionally, the inlet 64 and the outlet 66 may be generally perpendicular with respect to one another, such as the end-suction, 90 degree discharge configuration illustrated in FIG. 2. Optionally, the inlet 64 is oriented in-line with the rotation axis 28 such that the fluid flows through the inlet 64, the manifold 16, the sleeve flange 44 and the pump stack 30 in a direction along the rotation axis 28, shown by the arrow A. Other configurations and orientations of the inlet and outlet 64 and 66 are contemplated in alternative embodiments, such as on the front end 50, top 54, bottom 56 or sides 58, 60 in a non-in-line configuration.

Optionally, the manifold 16 may include an inlet fitting 68 and an outlet fitting 70 coupled to the inlet 64 and outlet 66, respectively. The fittings 68, 70 are separately provided from the manifold 16 and mountable thereto. The fittings 68, 70 may be securely coupled to the manifold 16 using known fasteners or fastening methods. For example, the fittings 68, 70 may be threadably coupled to the manifold 16; the fittings 68, 70 may be coupled to the manifold 16 using integral flanges and corresponding fasteners; the fittings 68, 70 may be soldered or welded to the manifold 16; and the like. The fittings 68, 70 are also configured for attachment to the supply and discharge pipes, respectively, such as by a flange coupling, a threaded coupling, a soldered coupling, and the like. The type and size of fitting 68, 70 (e.g. flange, threaded, and the like) may be selected based on the type of mating fitting included on the supply and discharge pipes. A modular manifold 16 is thus provided that may be adapted lor installation to an existing piping system. Optionally, the types of fittings 68, 70 may be the same and/or the size of the opening of the fittings 68, 70 may be the same. Alternatively, the type and/or size of the fittings 68, 70 may be different than one another.

In the illustrated embodiment, the outlet fitting 70 constitutes a modular discharge spool having first and second flanges at the ends thereof. Multiple discharge spools may be provided with the pump assembly 10, wherein each spool has different dimensions, such as opening size, flange size, height, width, length, thickness, fitting type, and the like. The discharge spools are interchangeable with the manifold 16 to accommodate a range of discharge pipe configurations.

In the illustrated embodiment, the inlet fitting 68 constitutes a victaulic connection using a snap ring (not shown) and corresponding grooves on each of the inlet fitting 68 and the manifold 16 at the inlet 64. The inlet fitting 68 also includes a flange for interconnection with the supply pipe, however, other types of interconnection may be accomplished in lieu of the flange coupling.

Optionally, multiple fittings may be provided with the pump assembly 10, wherein each fitting has different dimensions, such as opening size, flange size, height, width, length, thickness, fitting type, and the like. The multiple fittings are interchangeable with the manifold 16 to accommodate a range of supply pipe configurations. In alternative embodiments, other connecting methods and devices may be employed, such as a threaded coupling, a welded or soldered coupling, and the like. Optionally, seals may be positioned between the fittings 68, 70 and the manifold 16 to seal the interconnection therebetween. In alternative embodiments, the fittings 68, 70 may be integrally formed with the manifold 16 and positioned for interconnection with the supply and discharge pipes.

FIG. 2 is an exploded, partial cutaway view of a portion of the pump assembly 10 illustrating the cartridge 14 and the manifold 16. The pump head 40, the sleeve 42, the sleeve flange 44 and the manifold 16 are cutaway. As illustrated in FIG. 3, the cartridge 14 includes a seal cartridge 80 located between the pump head 40 and the pump shaft 34. The seal cartridge 80 seals against fluid leakage from the cartridge 14 at the pump head 40. The pump shaft 34 is rotatable within the seal cartridge 80 and the seal cartridge 80 operates to seal the fluid from escaping from the cartridge 14.

The pump stack 30 extends from a first end 82 to a second end 84 and includes multiple pumping stages 32 between the first and second ends 82, 84. Any number of stages may be provided depending on the particular application and the desired now rate or pressure of the pump assembly 10. The first end 82 is located proximate the manifold 16, and in the exemplary embodiment, the sleeve flange 44 is provided at the first end 82. The second end 84 is located proximate the pump head 40, and in the exemplary embodiment, the pump head 40 is provided at the second end 84. The pumping stages 32 each include an impeller (not shown) therein that is coupled to the pump shaft 34. The impeller rotates to channel the fluid through the corresponding stage. Optionally, each pumping stage 32 includes a diffuser 86 shaped to force the fluid from an upstream stage to a downstream stage as the fluid is pumped from the first end 82 to the second end 84. Each stage includes a single impeller and a single diffuser 86. Additionally, the first pumping stage 32 includes a diffuser represented by a suction interconnector 89 at the upstream end of the first stage. The suction interconnector 89 is sized to interconnect the sleeve flange 44 and the downstream diffusers 86. In the illustrated embodiment, the pump stack 30 includes an end wall 91. The end wall 91 includes an opening 93 therethrough providing a flow path to a first of the pumping stages. The end wall 91 engages and is supported by the sleeve flange 44 once assembled. The end wall 91 includes a necked down portion having a reduced diameter at the end thereof for joining with the sleeve flange 44. Optionally, at least one of the stages may constitute a bearing stage that includes a bearing for supporting the pump shaft 34. Such bearing stages are used more often in longer pump stacks 30.

The pumping stages 32 include an outer surface 88 spaced radially outward from the pump shaft 34 and spaced radially inward from the sleeve 42. A suction, or radially inward, chamber 90 is positioned between the outer surface 88 of the pumping stages 32 and the pump shaft 34. The impellers are positioned within the suction chamber 90. A discharge, or radially outward, chamber 92 is positioned between the outer surface 88 of the pumping stages 32 and the sleeve 42. The suction and discharge chambers 90, 92 are axially aligned, but radially split or spaced with respect to one another. The suction chamber 90 is in fluid communication with, and extends between the inlet 64 of the manifold 16 and the discharge chamber 92, and the discharge chamber 92 is in fluid communication with, and extends between the suction chamber 90 and the outlet 66 of the manifold 16.

As described above, the sleeve flange 44 is located at the first end 82 of the pump stack 30. The sleeve flange 44 includes an outer surface or outer ring 94, from which a flange portion 96 of the sleeve flange 44 extends. The volute flange 62 is coupled to the flange portion 96 during assembly of the pump assembly 10. The outer surface 94 has a substantially circular cross section and is sized substantially the same as the sleeve 42. Optionally, the outer surface 94 includes an outer cartridge engagement surface 95, and a portion of the cartridge 14, such as the sleeve 42, engages the outer cartridge engagement surface 95. The sleeve flange holds the vertical position of the sleeve 42 with respect to the downward, gravitational forces on the sleeve 42. The outer surface 94 defines an extension of the sleeve 42 wherein an end of the outer surface 94 abuts the first end 82 of the sleeve 42 and continues upstream from the sleeve 42. Alternatively, the outer surface 94 may be slightly larger than the sleeve 42 such that the sleeve 42 may fit within the outer surface 94 in sealing engagement. Optionally, a seal (not shown) may be positioned between the outer surface 94 and the sleeve 42 for sealing the connection therebetween. The seal and/or the sleeve 42 may be received within an annular groove 98 in the outer surface 94. Optionally, the annular groove 98 is positioned at a rear end of the sleeve flange 44.

The sleeve flange 44 further includes a concentric ring 100 positioned radially inward with respect to the outer surface 94. The ring 100 defines an inner cartridge engagement surface 97, and a portion of the cartridge 14, such as the end wall 91, engages the inner cartridge engagement surface 97. Optionally, a seal may be provided between the engagement surface 97 and the cartridge 14. The concentric ring 100 is positioned to separate water flowing within the suction chamber 90 from water flowing within the discharge chamber 92. Optionally, the concentric ring 100 operates as an extension of the outer surface 88 of the pumping stages 32. The concentric ring 100 is supported and positioned by braces 102 extending between the concentric ring 100 and the outer surface 94. The ring 100 holds the vertical position of the pump stack 30 to be centered within the sleeve 42. The ring 100 controls the relative position of the pump stack 30 with respect to the sleeve 42. An inner annulus 99 is defined radially inward of the ring 100. An outer annulus 101 is defined between the ring 100 and the outer surface 94. The inner annulus 99 connects the opening 93 and suction chamber 90 with an inner chamber 120 of the manifold 16. The outer annulus 101 connects the outer or discharge chamber 92 with an outer chamber 122 of the manifold 16. As such, the sleeve flange 44 defines two flow paths.

Optionally, the sleeve flange 44 may include a bearing support 104 at a central portion of the sleeve flange 44. The bearing support 104 includes a mating bearing 106 that engages with a corresponding mating bearing 108 of the pump shaft 34. The bearing support 104 operates to support the mating bearings 106, 108 and the pump shaft 34. The bearing support 104 is supported by braces 110 extending between the concentric ring 100 and the bearing support 104.

The manifold 16 includes the inner chamber 120 and the outer chamber 122. The inner chamber 120 is in fluid communication with the inlet 64 and the outer chamber 122 is in fluid communication with the outlet 66. The inner chamber 120 extends between the inlet and the concentric ring 100 of the sleeve flange 44, and restricts fluid flow directly between the inlet 64 and the outlet 66. In the illustrated embodiment the inner chamber 120 is axially aligned with the inlet 64 and the suction chamber 90 of the pump stack 30 and extends axially along the rotation axis 28. The inner chamber 120 channels all of the fluid entering the inlet 64 to the suction chamber 90 via the sleeve flange 44. Optionally, the inner chamber 120 includes a transition section 124 that changes size from the upstream end to the downstream end. In the illustrated embodiment, the transition section 124 increases in diameter from the upstream end to the downstream end. The diameter of the inner chamber 120 is substantially equal to the diameter of the concentric ring 100. Optionally, registers 126 and 128 are provided on each of the concentric ring 100 and the manifold 16 at the rear end 52 where the manifold 16 is joined to the sleeve flange 44. The register 128 of the sleeve flange 44 defines an inner engagement surface that engages and is sealed against the manifold 16. The outer surface 94 of the sleeve flange 44 defines an outer engagement surface that engages and is sealed against the manifold 16.

The outer chamber 122 extends between the front end 50 and the rear end 52 of the manifold 16. The outer chamber 122 is positioned radially outward with respect to the inner chamber 120, and completely surrounds the inner chamber 120. The outer chamber 122 is axially aligned with the outer chamber 92 of the cartridge 14 and receives fluid therefrom and directs the fluid to the outlet 66.

In operation, water or another fluid enters the manifold 16 at the inlet 64 via the inlet fitting 68 from the supply pipe. In the illustrated embodiment, the fluid flows axially through the inlet 64 and through the manifold 16 to the pump stack 30. Between the inlet 64 and the outlet 66, the fluid is pumped through the multistage pump stack 30, wherein the pressure of the fluid is increased based on the number of stages within the pump stack 30 at a given rotational speed. Within the pump stack 30, the fluid initially passes through the suction interconnector 89 of the first, or upstream, stage of the pump stack 30. The suction interconnector 89 defines the upstream end of the suction chamber 90. The fluid is channeled by the suction interconnector 89 and/or the diffuser 86 into a bottom runner or impeller of the first pump stage, and the impeller forces the fluid to the diffuser 86 of the first stage. The diffuser 86 of the first stage channels the fluid into the impeller of the second stage. Correspondingly, a plurality of stages may be arranged one after another depending on the pressure differential required. For example, any number of pump stages may be selected depending on the particular outlet fluid requirements, such as flow, pressure, and the like, and sleeves 42 of various lengths may be provided to accommodate the chosen number of pump stages. The staybolts 46 may also be sized accordingly to hold the pump unit together. Optionally, the pump assembly 10 may include a single stage.

In accordance with one embodiment, a pump family may be provided with pump units having a different number of stages. For example, a first pump unit may have M number of pumping stages 32 and a second pump unit may have N number of pumping stages 32 that is greater than the M number of pumping stages of the first pump unit. Any one of the pump units may be alternatively, separately coupled to the one manifold 16 mounted within the pipe system depending on the water demand at the discharge of the pump. The manifold 16 remains attached to the supply and discharge pipes while the cartridge 14 and/or pump motor 12 are switched out. The carrier assembly 20 is used to uncouple the cartridge 14 and pump motor 12 from the manifold 16. For example, the carrier assembly 20 slides rearward from the manifold 16 to move the cartridge 14 and pump motor 12 away from the manifold 16. Additionally, if the water demand changes, the pump unit may be changed thereby increasing or decreasing the number of pumping stages 32 associated with the manifold 16 to accommodate the fluid demand of the particular application. Given that each pump unit is capable of fitting with the same manifold 16, a pump family is provided that has a modular design that increases efficiency, such as by reducing part count and/or by reducing assembly time. Additionally, the pump family may include multiple different sized manifolds, wherein all or a subset of a plurality of pump units are configured to mate with each manifold.

Once the fluid is forced through the last pump stage, the fluid is conveyed to the discharge chamber 92. The fluid is channeled through the discharge chamber 92 to the outer chamber 122 of the manifold 16. The outer surface 88 of the pumping stages 32 separates and isolates the inner and outer chambers 90, 92. Similarly, the concentric ring 100 separates or isolates the fluid flowing between the inner chambers 90, 120 from the fluid flowing between the outer chambers 92, 122. The fluid within the annular space of the outer chamber 122 of the manifold 16 is expelled from the manifold 16 through the outlet 66 and into the discharge pipe.

In an exemplary embodiments as described above, the cartridge 14 is removable from the manifold 16, such as for servicing the cartridge 14. For example, the service may include assembling, repairing or replacing some or all of the components of the cartridge 14. The manifold 16 is coupled to the supply and discharge pipes. When the cartridge 14 is removed, the manifold 16 may remain connected to the supply and discharge pipes. As such, servicing of the pump assembly 10 may be accomplished more quickly. For removal, fasteners connecting the end plate 44 to the manifold 16 may be removed, and the pump unit (e.g. end plate 44, sleeve 42 pump head 40 and pump stack 30) may be de-coupled from the manifold 16. During servicing, the sleeve 42 may be removed and the pumping stages exposed. Any number of the pumping stages may be repaired or replaced and the pump unit reassembled. The pump unit, or a new pump unit, may then be re-coupled to the manifold 16. The pump unit may or may not have the same number of pumping stages.

During de-coupling and re-coupling, the end plate 44 is used to hold the pumping stages in place as a pump unit. The end plate 44 also holds the pump shaft 34 in position with respect to the pumping stages and/or the sleeve 42. Additionally, when a new pump unit is re-coupled to the manifold 16, the new pump unit may have a different configuration, such as shape, size or diameter as the pump unit being replaced. When a pump unit having a different size or shape is re-coupled to the manifold 16, the end plate 44 used may have a mating end for mating with the manifold 16 that is substantially the same as the end plate of the old pump unit such that the same manifold 16 may be used and different types and/or sizes of end plates 44 may be attached to the same manifold 16.

During de-coupling, the carrier assembly 20 moves the cartridge 14 away from the manifold 16 in a horizontal, axial direction, such as along the rotation axis 28, at least until the pump unit clears the manifold 16. The pump unit may then be turned generally vertically for servicing so that each of the pumping stages may rest directly upon one another. During re-coupling, the carrier assembly 20 moves the cartridge 14 toward the manifold 16 in a horizontal, axial direction, such as along the rotation axis 28, until the end plate 44 is loaded into the manifold 16. The pump shaft 34 and pump stack 30 are held horizontally by the end plate 44 such that the pump shaft 34 and pump stack 30 may be properly vertically positioned with respect to the manifold 16 so as to not obstruct assembly.

FIG. 3 illustrates the pump assembly 10 in a retracted state with the cartridge 14 retracted from the manifold 16. In the retracted state, the manifold 16 remains stationary. The cartridge 14 and the pump motor 12 are slid rearward away from the manifold 16. The fasteners holding the end plate 44 to the manifold 16 are initially unfastened to allow the end plate 44 to separate from the manifold 16. The cartridge 14 and the pump motor 12 are slid rearward by the carrier assembly 20 as a unit. Optionally, the pump stack support 22 is also slid rearward with the cartridge 14 and the motor pump 12. The cartridge 14 and the pump motor 12 are slid rearward by a distance 150 sufficient to allow the fasteners and components of the end plate 44 to clear the manifold 16, such that the cartridge 14 may be lifted away from the base 18.

The carrier assembly 20 includes a support frame 152 and a pair of outwardly extending rails 154 coupled to the baseplate 26. The rails 154 may be secured to the baseplate 26, such as by welding. The rails 154 are elevated above the baseplate 26. Any number of rails 154 may be provided. The support frame 152 slides along the rails 154 in a linear direction. In an exemplary embodiment, the rails 154 extend parallel to the longitudinal axis 28 of the pump assembly 10.

The support frame 152 includes frame walls 156 connected to a mount 158. Optionally, the mount 158 may be part of the pump motor 12. Alternatively, the mount 158 may be a separate component coupled between the frame walls 156. The pump motor 12 may rest upon the mount 158. The frame walls 156 have grooves 160 formed therein that fit on the rails 154. The grooves 160 hold the frame walls 156 in alignment with the rails 154. The frame walls 156 have a height 162 measured from the baseplate 26. The height 162 controls the vertical height of the pump motor 12. Optionally, many different frame walls 156 having different heights 162 may be provided. Appropriate frame walls 156 may be selected depending on the particular pump motor 12 and manifold 16 combination such that the pump motor 12 may be aligned with the manifold 16. If a different motor is selected, different frame walls 156 may be arranged between the pump motor 12 and the rails 154.

The rails 154 have a length 164. The length 164 may be selected to accommodate different pump motors 12 and/or cartridges 14. The length 164 of the rails 154 provides a range of motion that allows the pump motor 12 and cartridge 14 to be moved towards and away from the manifold 16. Because different cartridges 14 and pump motor 12 may be used and coupled to the same manifold 16, the length 164 of the rails 154 may be oversized to accommodate a family of pump assembly. For example, in order to accommodate a first type of cartridge 14 having, for example, two pumping stages 32, and to accommodate a second type of cartridge 14 having, for example, ten pumping stages, the length 164 of the rails 154 may be larger than required for the first type of cartridge 14. The length 164 may be greater than required to accommodate the second type of cartridge 14, such as to accommodate a cartridge 14 having more than ten pumping stages. A stop 166 may be provided near the rear end or the rails 154 to limit rearward movement of the support frame 152 along the rails 154. A set screw 168 may be coupled to one or more of the frame walls 156 to secure the position of the support frame 152 along the rails 154. For example, when the carrier assembly 20 is advanced to the point where the end plate 44 engages the manifold 16, the set screw 168 may be tightened to secure the position of the support frame 152 along the rails 154. Other types of locking mechanisms may be provided in alternative embodiments to secure the carrier assembly 20 to the baseplate 26.

In the retracted position, the cartridge 14 is removable for servicing and/or replacement, such as replacement with a different cartridge 14. In one embodiment, the cartridge 14 is removable from the motor coupler 38, such as by removing fasteners securing the cartridge 14 to the motor coupler 38. In another embodiment, the cartridge 14 and motor coupler 38 are removable as a unit from the motor pump 12, such as by removing fasteners securing the motor coupler 38 to the pump motor 12.

Once removed, the cartridge 14 may be disassembled. For example, the staybolts 46 holding the end plate 44 and the pump head 40 together may be removed. The pump head 40 and/or the end plate 44 may then be removed from the cartridge 14. The pump stack 30 may be removed from the sleeve 42 after the pump head 40 and/or end plate 44 are disassembled. Optionally, the pump stack 30 may be oriented vertically prior to being pulled out of the sleeve 42. Removal of the pump stack 30 allows for servicing. The pumping stages 32 may be disassembled once the pump stack 30 is exposed. The pump shaft 34 may likewise be accessed for servicing once the pump stack 30 is exposed. Selected pump stages 32 may be repaired or replaced. Optionally, each of the pumping stages 32 may be repaired or replaced. Pumping stages 32 may be added to or removed from the pump stack 30.

The cartridge 14 may be reassembled in a similar manner. For example, the pump stack 30 may be received in the sleeve 42. The pump head 40 and the end plate 44 may be arranged at the first and second ends of the sleeve 42 and pump slack 30. The staybolts 46 may be coupled to the pump head 40 and/or the end plate 44. Once the cartridge 14 is reassembled, the cartridge 14 may be coupled to the motor coupler 38 and/or the pump motor 12.

Alternatively, rather than replacing the same cartridge 14, a new cartridge may be coupled to the motor coupler 38 and/or the pump motor 12 in place of the removed to cartridge 14. The new cartridge 14 may have a different number of pumping stages 32. Optionally, both the cartridge 14 and the pump motor 12 may be removed and replaced with a different cartridge 14 and a different pump motor 12, respectively. The new cartridge 14 and pump motor 12 may be sized differently to change the pump characteristics.

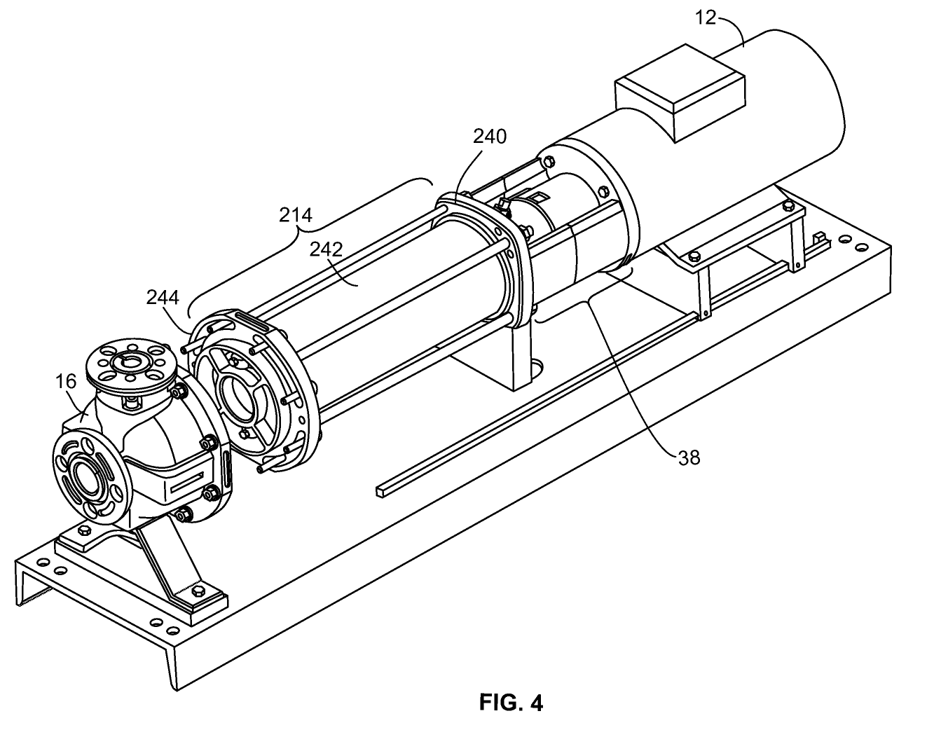

FIG. 4 illustrates the pump assembly with an alternative cartridge 214 being coupled to the manifold 16. The cartridge 214 has similar dimensions as the cartridge 14, however the cartridge 214 is axially longer. The cartridge 214 includes more pumping stages 32 than the cartridge 14. The cartridge 214 includes a pump head 240, a sleeve 242, an end plate 244 and a pump stack (not shown). The pump head 240 may be substantially identical to the pump head 40. The end plate 244 may be substantially identical to the end plate 44. The sleeve 242 may have a similar diameter as the sleeve 42, however the sleeve 242 is axially longer than the sleeve 42. Because features of the cartridge 214 are the same or similar to the cartridge 14, the cartridge 214 may be coupled to the motor coupler 38 and/or the pump motor 12. The cartridge 214 may also be coupled to the manifold 16 without needing to replace the manifold 16 with a differently sized or shaped manifold.

Once the cartridge 214 is coupled to the motor coupler 38, the carrier assembly 20 may be slid forward in an advancing direction towards the manifold 16. The carrier assembly 20 is advanced until the end plate 244 engages the manifold 16. The end plate 244 is securely coupled to the manifold 16 by fasteners.

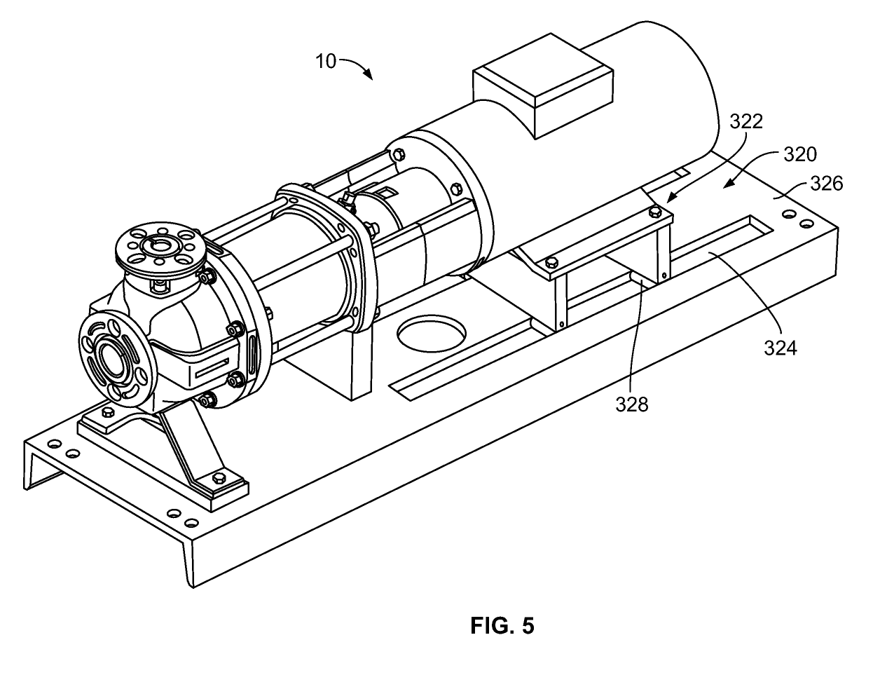

FIG. 5 illustrates an alternative carrier assembly 320 for the pump assembly 10. The carrier assembly 320 includes a support frame 322 and a pair of rails 324. The rails 324 are defined by an inwardly extending track that extends into a baseplate 326. The support frame 322 includes rollers 328 received within the rails 324. The rollers 328 allow linear movement of the carrier assembly 320 towards and away from the manifold 16. The rails 324 guide the rollers 328.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second.” and “third.” etc. are used merely as labels, and are not intended to impose numerical requirements on their objects. Further, the limitations of the following claims are not written in means—plus-function format and are not intended to be interpreted based on 35 U.S.C. § 112, sixth paragraph, unless and until such claim limitations expressly use the phrase “means for” Followed by a statement of function void of further structure.

What is claimed is:

1. A pump assembly comprising:
a manifold having an inlet port configured to be coupled to a supply pipe and an outlet port configured to be coupled to a discharge pipe;
a cartridge having a pump stack including a plurality of pumping stages, each pumping stage including an impeller, the cartridge extending between a first end and a second end, the first end being removably coupled to the manifold; and
a carrier assembly supporting the cartridge, the carrier assembly moving the cartridge between an advanced position and a retracted position, the cartridge engaging the manifold in the advanced position, the cartridge disengaging from the manifold in the retracted position.

2. The pump assembly of claim 1, wherein the carrier assembly includes a support frame and at least one rail, the support frame being slidable along the rail, the cartridge being supported by the support frame.

3. The pump assembly of claim 1, wherein the carrier assembly includes a baseplate and a support frame, the cartridge being supported by the support frame, the baseplate being parallel to a rotation axis of the impellers, the support frame being movable in a linear direction along the baseplate.

4. The pump assembly of claim 1, wherein the carrier assembly includes a baseplate, the manifold being fixedly coupled to the baseplate, the cartridge being movable along the baseplate toward and away from the manifold.

5. The pump assembly of claim 1, further comprising a pump motor, the cartridge being coupled to the pump motor, the carrier assembly supporting the pump motor and the cartridge, the cartridge and the pump motor being simultaneously movable toward and away from the manifold between the advanced position and the retracted position, respectively.

6. The pump assembly of claim 1, wherein the cartridge includes an end plate at the first end, the end plate including a separable interface engaging the manifold and disengaging from the manifold in the advanced position and the retracted position, respectively.

7. The pump assembly of claim 1, wherein the cartridge includes an end plate supporting the pump stack at the first end, the cartridge including a pump head supporting the pump stack at the second end, the pump head being coupled to the end plate by tie rods such that the cartridge is removable from the manifold and from the carrier assembly as a unit.

8. The pump assembly of claim 1, further comprising a pump motor supported by the carrier assembly, the cartridge including an end plate supporting the pump stack at the first end and a pump head supporting the pump stack at the second end, the pump head being coupled to the end plate by tie rods such that the cartridge is removable from the manifold and from the pump motor as a unit.

9. The pump assembly of claim 1, wherein the cartridge includes a sleeve surrounding the pump stack defining an outer chamber between the pump stack and the sleeve, fluid flows within the outer chamber from the pump stack to the manifold, the cartridge including an end plate separably coupled to the manifold, the end plate including an outer cartridge engagement surface supporting the sleeve and an inner cartridge engagement surface supporting the pump stack.

10. The pump assembly of claim 1, wherein the pump stack includes a pump shaft extending along a rotation axis, the rotation axis being arranged horizontally to define a horizontal, multistage pump assembly, the carrier assembly moving the cartridge in a horizontal direction to disengage the cartridge from the manifold.

11. The pump assembly of claim 1, wherein the pump stack includes a pump shaft extending along a rotation axis, the inlet port extends along the rotation axis such that flow passes straight through the manifold to the pump stack.

12. A method of servicing a pump assembly that includes a manifold and a cartridge removably coupled to the manifold the manifold being coupled to a supply pipe and a discharge pipe, the method comprising:
providing a carrier assembly including a support frame and a rail, the support frame being movable along the rail, the cartridge being supported by the support frame and the cartridge being coupled to the manifold;
uncoupling the cartridge from the manifold, and
guiding the support frame and the cartridge along the rail away from the manifold to a retracted position.

13. The method of claim 12, further comprising:
guiding the support frame and the cartridge along the rail toward the manifold to an advanced position where the cartridge engages the manifold; and
coupling the cartridge to the manifold.

14. The method of claim 12, further comprising removing the cartridge from the support frame.

15. The method of claim 12, further comprising replacing the cartridge with a new cartridge.

16. The method of claim 12, further comprising replacing the cartridge with a new cartridge having a different number of pumping stages as the replaced cartridge.

17. The method of claim 12, further comprising:
providing a pump motor mounted to the support frame, the cartridge being removably coupled to the pump motor; and
uncoupling the cartridge from the pump motor after the cartridge is moved away from the manifold.

18. A pump family of multistage pump assemblies comprising:
a manifold having an inlet port configured to be coupled to a supply pipe and a outlet port configured to be coupled to a discharge pipe, the manifold having a mating interface;
a pump motor;
a carrier assembly supporting the pump motor, the carrier assembly moving the pump motor relative to the manifold;
a first pump unit including a cartridge having an end plate, a pump head opposite the end plate and a pump stack extending between the end plate and the pump head, the pump stack of the first pump unit having M number of pumping stages, and
a second pump unit including a cartridge having an end plate, a pump head opposite the end plate and a pump stack extending between the end plate and the pump head, the pump stack of the second pump unit having N number of pumping stages different than the M number of pumping stages of the first pump unit;
wherein the first and second pump units are configured to be separately coupled to the manifold and the pump motor, the end plates being configured to be coupled to the manifold at a separable manifold interface, the pump heads being configured to be coupled to the pump motor at a separable motor interface.

19. The pump family of claim 18, wherein only one of the first and second pump units are configured to be coupled to the manifold and pump motor at any given time.

20. The pump family of claim 18, wherein when the first pump assembly is coupled to the manifold and the pump motor, the cartridge of the first pump assembly is configured to be uncoupled from the manifold and moved by the carrier assembly to a retracted position, after which, the first pump assembly is configured to be removed and replaced with the second pump assembly, the second pump assembly being moved by the carrier assembly until the cartridge of the second pump assembly engages the manifold.

21. The pump family of claim 18, wherein the end plate of the first pump assembly is formed substantially identically as the end plate of the second pump assembly.

22. The pump family of claim 18, wherein the carrier assembly includes a support frame and at least one rail, the support frame being slidable along the rail, the rail having a length sufficient to allow cartridges having M number of pumping stages to be arranged between the pump motor and the manifold and cartridges having N number of pumping stages to be arranged between the pump motor and the manifold.
